(19) United States
(12) Patent Application Publication
(10) Pub. No.: US 2026/0139539 A1
(43) Pub. Date: May 21, 2026

(54) SHIMMING CONCEPTS AND METHODS FOR FENESTRATION UNITS

(71) Applicant: Pella Corporation, Pella, IA (US)

(72) Inventors: Todd A. Bernhagen, Pella, IA (US); Jaime Ogbourne, Pella, IA (US)

(73) Assignee: Pella Corporation, Pella, IA (US)

(21) Appl. No.: 19/393,921

(22) Filed: Nov. 19, 2025

Related U.S. Application Data
(60) Provisional application No. 63/722,880, filed on Nov. 20, 2024.

(51) Int. Cl. E06B 1/60

(52) U.S. Cl. CPC E06B 1/6069

(57) ABSTRACT

Systems and method for shimming fenestration units configured to be set into a rough opening of a building structure or wall. The fenestration units may include a shimming assembly coupled to a frame and including a carrier portion and an adjustment portion. The carrier portion may have an upper carrier surface defining at least one pawl extending away from the upper carrier surface and a lower carrier surface having a contact feature configured to be received within a channel of the frame. The adjustment portion may define a plurality of teeth and is configured to slide longitudinally along the carrier portion such that the at least one pawl is configured to slide along the plurality of teeth until a desired level of shimming is reached, at which point the carrier member and the adjustment member are locked in position.

### CROSS-REFERENCE TO RELATED APPLICATION

This application claims priority to U.S. Provisional Application No. 63/722,880, filed November 20, 2024, which is incorporated herein by reference in its entireties for all purposes.

### BACKGROUND

Inserting, centering, levelling, fixing, sealing, and/or insulating fenestration units (e.g., windows and doors) in a rough opening in a structure or a building can be time consuming. Generally, the industry norm is to use one or more shims (e.g., wooden shims) about a perimeter of the fenestration unit. During the process, multiple shims may be stacked on top of one another to achieve a desired stack height between the fenestration unit and the rough opening framing. The fenestration unit may be anchored to the rough opening framing after staking multiple shims, causing difficulties in keeping the stack of shims in place. After placement of the shims, a solid or liquid sealant and/or insulator subsequently placed positioned about the fenestration unit between the unit and the rough opening. Alignment during shimming, placement of the fenestration unit, and breaking off the shims is time consuming and can result in mis-alignment, decoupling dislocation, splintering, unintended damage, and other unwanted results as the fenestration unit is installed within the rough opening framing and as the shims are broken off.

### SUMMARY

Various examples and methods relate to shimming a fenestration unit within a rough opening framing. In some examples, the fenestration unit includes a shimming assembly coupled to the frame that includes a carrier portion and an adjustment portion that engage each other in a ratchet mechanism. The adjustment portion may be longitudinally slid along the carrier portion such that the shimming assembly releasably locks at a desired position and holds the fenestration unit in a shimmed position within the rough opening framing. One or more shimming assemblies may be positioned about a perimeter of the frame, including at a top member, a side member, or a lower member. The shimming assembly may reduce the need to use additional tools during a shimming procedure.

According to one example (“Example 1”), a fenestration unit is configured to be received within a rough opening defined by a rough opening framing. The fenestration unit has a frame having a perimeter, the perimeter including a first side member, a second side member opposite the first side member, a upper member, and a lower member opposite the upper member, the frame defining a channel along at least a portion of the perimeter and a shim assembly. The shim assembly includes a carrier portion having an upper carrier surface and a lower carrier surface, the lower carrier surface having a contact feature configured to be received within the channel to couple the shim assembly to the frame, the upper carrier surface defining at least one pawl extending away from the upper carrier surface and an adjustment portion having an upper adjustment surface and a lower adjustment surface, the lower adjustment surface defining a plurality of teeth, and the adjustment portion is configured to slide longitudinally along the carrier portion such that the at least one pawl is configured to slide along the plurality of teeth until a desired level of shimming is reached, at which point the carrier member and the adjustment member are locked in position.

According to another example (“Example 2”), further to Example 1, the shim assembly is coupled to one of the first side member, the second side member, the upper member, or the lower member.

According to another example (“Example 3”), further to Example 1, the adjustment portion is configured to slide along the carrier portion such that the at least one pawl is configured to slide along a portion of the plurality of teeth.

According to another example (“Example 4”), further to Example 1, engagement of the at least one pawl and the plurality of teeth produces an audible cue.

According to another example (“Example 5”), further to Example 1, each tooth of the plurality of teeth are spaced approximately 0.01 inches apart from each other.

According to another example (“Example 6”), further to Example 1, the at least one contact feature is rotatable between a locked and unlocked configuration within the channel.

According to another example (“Example 7”), further to Example 1, the at least one contact feature is a non-penetrating feature.

According to another example (“Example 8”), further to Example 1, the shimming assembly includes a handle, and the handle is connected to the shimming assembly by a break off connection.

According to another example (“Example 9”), further to Example 1, the lower adjustment surface defines an inclined adjustment surface and the upper carrier surface defines an inclined carrier surface, and the lower adjustment surface and the upper carrier surface are configured to slide across one another in response to an external force.

According to another example (“Example 10”), further to Example 9, the carrier portion defines a pair of retention members extending longitudinally along the inclined carrier surface, and the adjustment portion defines a pair of retainers extending longitudinally along the inclined adjustment surface, the engagement of the pair of retention members and the pair of retainers configured to maintain a coupling of the carrier portion and the adjustment portion.

According to another example (“Example 11”), further to Example 10, each retention members of the pair of retention members defines a hooked end.

According to one example (“Example 12”), a fenestration unit a method of shimming a fenestration unit within a rough opening of a structure includes a frame having a perimeter including a first side member, a second side member opposite the first side member, a upper member, and a lower member opposite the upper member and defining an interior side facing an interior of the structure and an exterior side facing an exterior of the structure, the rough opening defined by a rough opening framing. A method of shimming the fenestration unit with the rough opening includes rotating a shimming assembly coupled to the perimeter of the frame about a non-penetrating contact feature coupled to the shimming assembly such that the shimming assembly extends outwardly from the perimeter of the frame toward the exterior side, applying an external force to a portion of the shimming assembly such that an adjustment portion of the shimming assembly slides longitudinally relative to a carrier portion of the shimming assembly such that at least one pawl of the carrier portion engages a plurality of teeth of the adjustment portion, and removing the external force when a desired level of shimming is reached such that a position of the adjustment portion and the carrier portion is locked.

According to another example (“Example 13”), further to Example 12, the method further includes anchoring the fenestration unit to the rough opening framing, and optionally coupling an anchoring bracket of the fenestration unit to the rough opening framing.

According to another example (“Example 14”), further to Example 13, the method further includes breaking off a first portion of the shimming assembly after anchoring the fenestration unit.

According to another example (“Example 15”), further to Example 12, the method further includes rotating the shimming assembly approximately 90 degrees to lock the non-penetrating contact feature to the perimeter of the frame such that a rib of the carrier portion engages a portion of the frame.

According to another example (“Example 16”), further to Example 12, the shimming assembly is coupled to the upper frame member, the method further includes lowering a position of the fenestration unit relative to the rough opening framing.

According to another example (“Example 17”), further to Example 12, the shimming assembly is coupled to one of the first or second frame members, the method further including moving a position of the fenestration unit laterally relative to the rough opening framing.

According to another example (“Example 18”), further to Example 12, the shimming assembly is coupled to the lower frame member, the method further comprising including a position of the fenestration unit relative to the rough opening framing.

According to another example (“Example 19”), further to Example 12, the method further includes releasing the at least one pawl from a tooth of the plurality of teeth to unlock the position of the adjustment portion and the carrier portion.

According to another example (“Example 20”), further to Example 12, the method further includes coupling the shimming assembly to a channel extending along a portion of the perimeter of the frame, the shimming assembly being coupled to one of the upper member, the first side member, the second side member, and the lower member, optionally wherein coupling the shimming assembly to the channel requires no additional tooling.

The foregoing examples are just that and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a front view of an interior side of a fenestration unit as viewed from an interior side of a structure, in accordance with some embodiments;

FIG. 2 is a side-oriented perspective view of the fenestration unit of FIG. 1 including a shimming assembly, in accordance with some embodiments;

FIG. 3A is a side-oriented view of the shimming assembly of FIG. 2, in accordance with some embodiments;

FIG. 3B is a bottom-view of a coupling features of the shimming assembly of FIG. 3A, in accordance with some embodiments;

FIG. 4 is a cross-sectional view of a contact feature of the shimming assembly coupled to the fenestration unit in an unlocked position, in accordance with some embodiments;

FIG. 5 is a cross-sectional view of the contact feature of the shimming assembly coupled to the fenestration unit in a locked configuration, in accordance with some embodiments;

FIG. 6 is a side-oriented perspective view of a top side of the shimming assembly, in accordance with some embodiments;

FIG. 7. is a top-view of the shimming assembly, in accordance with some embodiments;

FIG. 8 is a side-oriented perspective view of a bottom side of the shimming assembly, in accordance with some embodiments;

FIG. 9 is a bottom-view of the shimming assembly, in accordance with some embodiments;

FIG. 10 is a side-oriented perspective view of an upper carrier surface of a carrier portion of the shimming assembly of FIG. 6, in accordance with some embodiments;

FIG. 11 is a side-oriented perspective view of a lower carrier surface of the carrier portion, in accordance with some embodiments;

FIG. 12 is a cross-sectional view of the carrier portion, in accordance with some embodiments;

FIG. 13 is a side-oriented perspective view of an upper adjustment surface of an adjustment portion of the shimming assembly of FIG. 6, in accordance with some embodiments;

FIG. 14 is a side-oriented perspective view of a lower adjustment surface of the adjustment portion, in accordance with some embodiments;

FIG. 15 is a cross-sectional view of the adjustment portion, in accordance with some embodiments;

FIG. 16 shows the shimming assembly coupled to the fenestration unit in an unlocked position, in accordance with some embodiments;

FIG. 17 shows the shimming assembly coupled to the fenestration unit in a locked position, in accordance with some embodiments;

FIG. 18 shows the shimming assembly in an intermediate position during a shimming action, in accordance with some embodiments;

FIG. 19 shows the shimming assembly in a final, shimmed position after the shimming action, in accordance with some embodiments; and

FIG. 20 is front view of the interior side of a fenestration unit including one or more anchoring clips, in accordance with some embodiments.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about”, “substantially” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

The terms “interior” and “exterior” are generally meant to reference opposite sides of a fenestration unit unless directly specified that “exterior” means exposed to the elements. For example, a fenestration unit installed within an interior of a building structure (e.g., a bedroom door) still has opposing “interior” and “exterior” sides as those terms are used in this patent specification, though the “exterior” is still disposed within the building structure itself.

The term “fenestration unit” is meant to cover any of a variety of products for providing venting, viewing, ingress, or egress from a building structure into which the fenestration unit is installed. Examples include doors, windows, and the like.

The term “structure” or “building” is meant to cover any of a variety of structures. Examples include single-family or multi-family homes, residential buildings, commercial buildings, and others.

The term “opening” as used in the context of a “structure” or “building” may include rough openings in the structure, including rough openings in an exterior wall or boundary of the structure or internal wall or boundary of the structure.

Relative terms such as “upper”, “lower”, “top”, “bottom”, “horizontal,” “vertical” and the like are construed broadly and are used to describe the orientation of components relative to one another, rather than in an absolute sense, unless otherwise indicated.

### Description of Various Embodiments

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale but may be exaggerated to illustrate various aspects of the present disclosure, and in that regard, the drawing figures should not be construed as limiting.

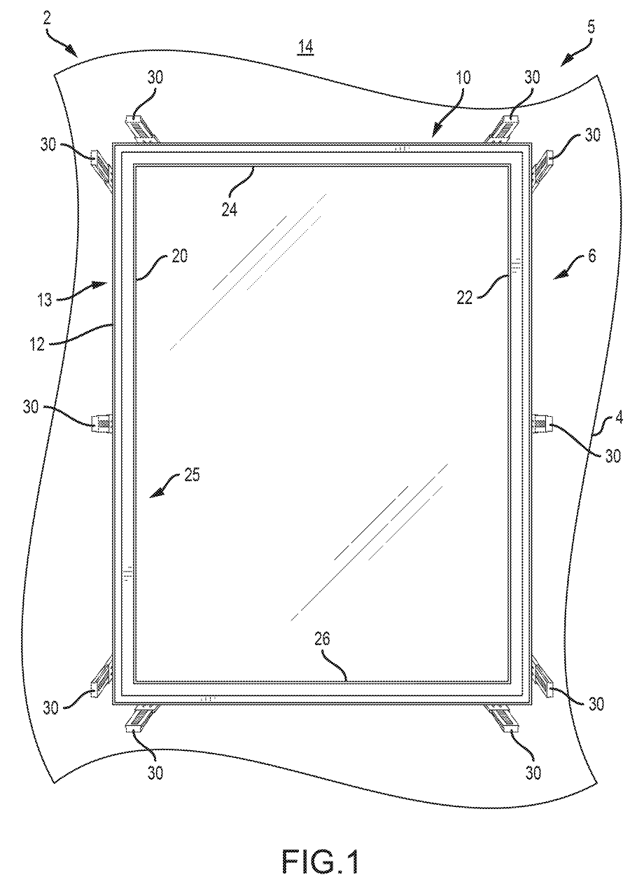

FIG. 1 is a front view of a fenestration unit installation 5 as viewed from an interior side 14, in accordance with some embodiments. As shown, the fenestration unit installation 5 includes a fenestration unit 10 as installed in a rough opening of the structure 2, including a seal system (e.g., sealant) and fasteners (not shown) for securing the fenestration unit 10 in place. The rough opening is defined by a rough opening framing 4.

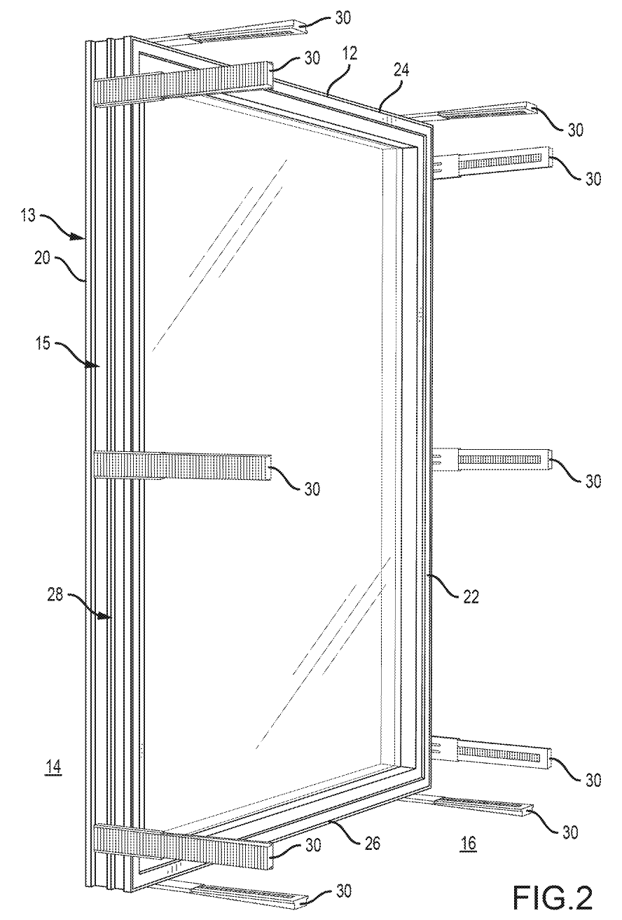

Further referring to FIG. 1, the fenestration unit 10 includes a frame 12, an interior side 14 (e.g., facing an interior side of the structure 2), an exterior side 16 opposite the interior side 14 (e.g., facing an exterior side of the structure 2), an intermediate portion 28 (FIG. 2) between the interior and exterior sides 14,16, and a perimeter 13 defined by the frame 12. The fenestration unit 10 is received in the rough opening in the structure 2 such that a gap 6 is defined around the perimeter 13 of the fenestration unit 10 between the fenestration unit 10 and the rough opening framing 4.

The frame 12 of fenestration unit 10 includes a plurality of frame members 25. In some embodiments, the plurality of frame members 25 includes a first side member 20 (e.g., a first jamb), a second side member 22 (e.g., a second jamb), a upper member 24 (e.g., a head), and a lower member 26 (e.g., a sill). Though a four-sided configuration of the fenestration unit 10 is shown and described by way of example, other configurations (e.g., three-sided, five-sided, six-sided, curve top, circle-head, and so forth) are contemplated.

The frame 12 and its components can be configured to maintain one or more glazing panels or other panels, which may include sheets of glass. The fenestration unit installation 5 may also include a seal system (not shown) extending continuously about the perimeter 13 of the fenestration unit 10 within the gap 6 between the fenestration unit 10 and the rough opening framing 4. The seal system may include an interior air seal in the form of at least one of flashing tape, foam, sealant, a backer rod, or combinations thereof (e.g., foam and sealant or the backer rod and sealant).

The fenestration unit 10 of FIG. 1 further includes one or more shimming assemblies 30 coupled to the perimeter 13 of the frame 12, and positioned in the gap 6 between the rough opening framing 4 and the frame 12. The shimming assemblies 30 may be substantially similar to one another and thus are subsequently described collectively with regard to one shimming assembly 30 (although it should be apparent that differing configurations between the plurality of shimming assemblies 30 are also contemplated).

FIG. 2 is a side-oriented perspective view of the fenestration unit 10 with a plurality of shimming assemblies 30 coupled thereto, in accordance with an embodiment. As shown in FIG. 2, one or more shimming assemblies 30 may be coupled along the first side member 20, the second side member 22, the upper member 24, or the lower member 26. As shown, with respect to the first and second side members 20, 22, one shimming assembly 30 may be coupled to the perimeter 13 near a top portion of the respective frame member 25 and another shimming assembly 30 may be coupled to the perimeter 13 near a bottom portion of the respective frame member. Similarly, with respect to the upper and lower members 24, 26, one shimming assembly 30 may be coupled to near a first side portion of the respective frame member 25 and another shimming assembly 30 may be coupled to the perimeter 13 near a second portion of the respective frame member. It is contemplated that a third shimming assembly 30 (not shown) could be coupled to the perimeter 13 near a central portion of the respective frame member 25.

Two shimming assemblies 30 are shown coupled to each frame member 25, though use of fewer shimming assemblies 30 (e.g., one shimming assembly 30) or more than two shimming assemblies 30 (e.g., three or more shimming assemblies 30) is also contemplated. In some examples, the number of shimming assemblies 30 coupled to the respective frame member 25 increases as the size of the fenestration unit 10 increases (e.g., a door may have more shimming assemblies 30 coupled to the perimeter 13 as compared to a window). Each of the shimming assemblies 30 are shown in a deployed configuration in which a longitudinal axis of the shimming assembly 30 extends generally perpendicular to the perimeter 13 of the frame 12, or said differently, the shimming assembly 30 extends away from a general center of the frame 12.

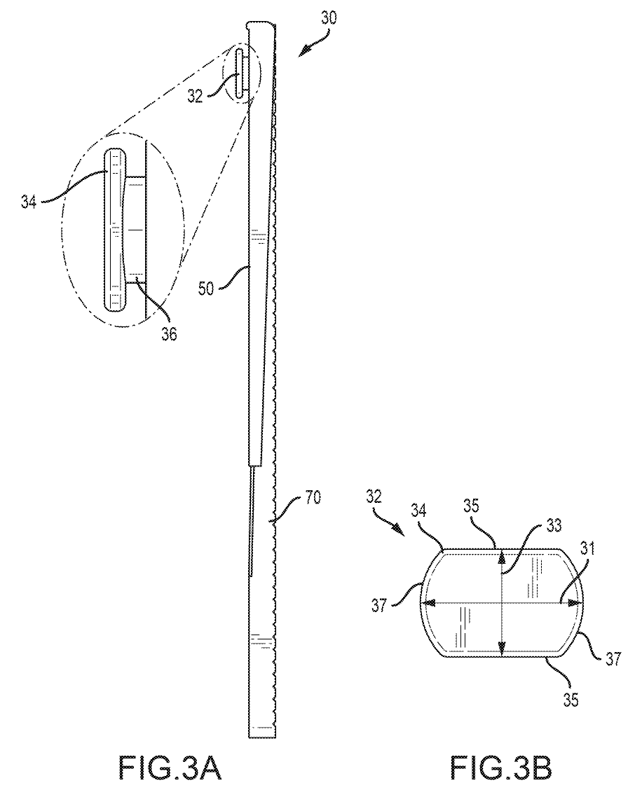

As shown in FIG. 2, the fenestration unit 10 defines a channel 15 (e.g., a T-slot, which, as the name implies, is a slot having a T-shaped cross-section) extending along at least a portion of the perimeter 13. In some embodiments, the channel 15 may extend continuously or discontinuously along one or more of the first side member 20, the second side member 22, and the upper member 24. The channel 15 is configured to receive a portion of the shimming assembly 30, such as a contact feature 32 (FIGS. 3A-3B), to couple the shimming assembly 30 to the frame 12.

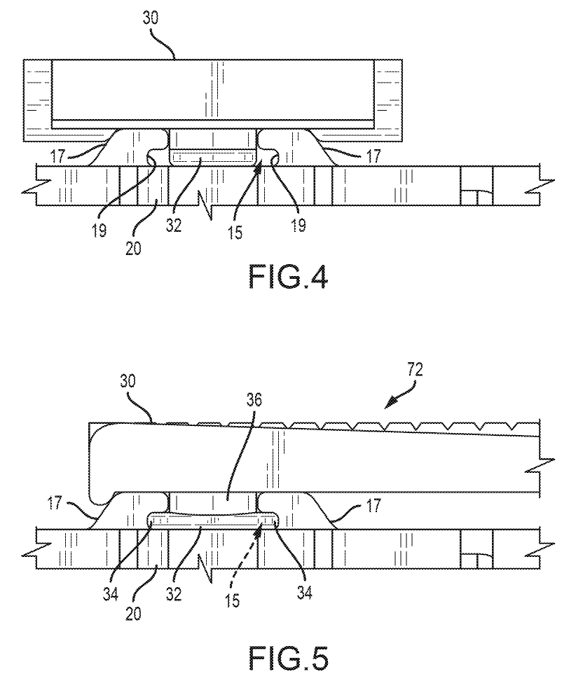

FIGS. 3A-3B shows a side-view of the shimming assembly 30 isolated from the fenestration unit 10. The contact feature 32 extends from a surface of the shimming assembly 30 and can include a non-penetrating feature configured to be received within the channel 15. A non-penetrating feature includes one that does not puncture through portions of the frame 12, or in other words, does not require a threaded hole or through hole for securement to the frame 12 (e.g., as opposed to a pre-formed hole for a fastener such as a screw or nail, or a hole formed by driving a screw or nail). In some examples, features that act as non-penetrating features may engage directly with the channel 15 defined by the frame 12 for securement thereon without needing to puncture the frame 12. In some examples, the contact feature 32 includes a pivotable or rotatable cam, pivotable between an unlocked configuration (FIG. 4) and a locked configuration (FIG. 5).

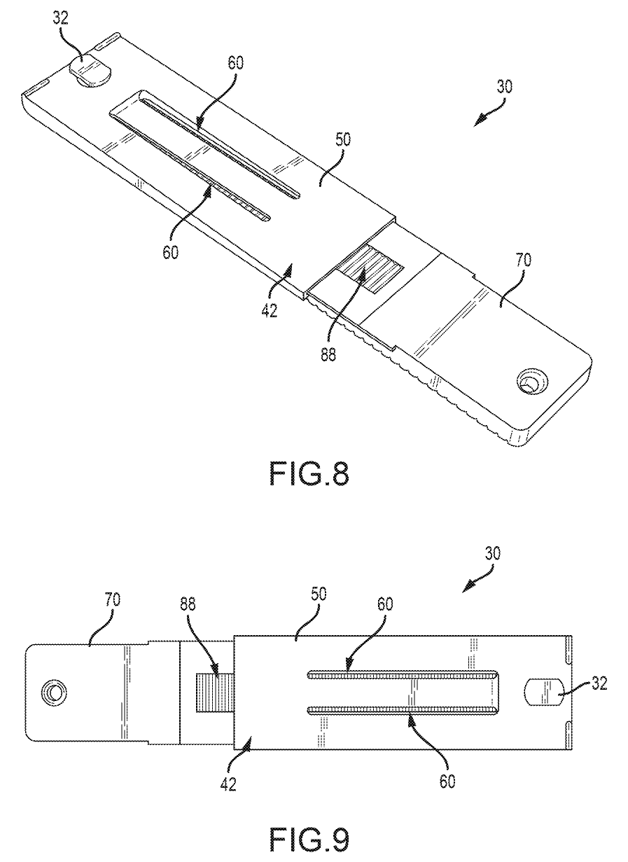

The contact feature 32 includes a waist portion 36 extending outwardly from the bottom side 42 (FIG. 8) of the shimming assembly 30 and a foot 34 extending outwardly from the waist portion 36. The foot 34 is configured to engage the channel 15, as described with respect to FIGS. 4-5. As shown in FIG. 3B, the foot 34 defines an eccentric shape with a major axis 31 and a minor axis 33. In one embodiment, the foot 34 includes two opposing edges 35 extending along the major axis 31 with a relatively linear or straight profile and two opposing edges 37 with generally curved profiles.

FIGS. 4-5 illustrate a cross-sectional view of the shimming assembly 30 coupled to the frame 12 in an unlocked and locked configuration, respectively, in accordance with an embodiment. In particular, FIGS. 4-5 show the contact feature 32 engaged within the channel 15. In an initial, or unlocked configuration, as shown in FIG. 4, the contact feature 32 is disposed apart from sidewalls 17 of the channel 15 and in thereby insertable within the channel 15. In particular, in the unlocked configuration, the foot 34 of the contact feature 32 extends substantially parallel to a length of the channel 15 such that the contact feature 32 can be received therein. The contact feature 32 can then be pivoted or rotated to the locked configuration, as shown in FIG. 5, such that the foot 34, and in particular the two opposing ends 37 of the foot 34, is positioned within an undercut portion 19 of the channel 15 and behind the sidewalls 17. In the locked configuration, the foot 34 is engaged within the channel 15 such that the shimming assembly 30 cannot be removed from the channel 15 without transitioning the contact feature 32 back to the unlocked configuration of FIG. 4. In this manner, the shimming assembly 30 is releasably lockable to the channel 15 of the fenestration unit 10. The contact feature 32 may be pivoted approximately 90 degrees between the unlocked and locked positions to release or secure, respectively, the shimming assembly 30 to the frame 12. As described, no additional tooling may be required to couple the shimming assembly 30 to the frame 12.

Alternatively, other coupling mechanisms between the fenestration unit 10 and the shimming assembly 30 may be used, such as penetrating fasteners (e.g., screws). For example, one or more penetrating fasteners can be driven through the shimming assembly 30 to couple the shimming assembly to the perimeter 13 of the frame 12.

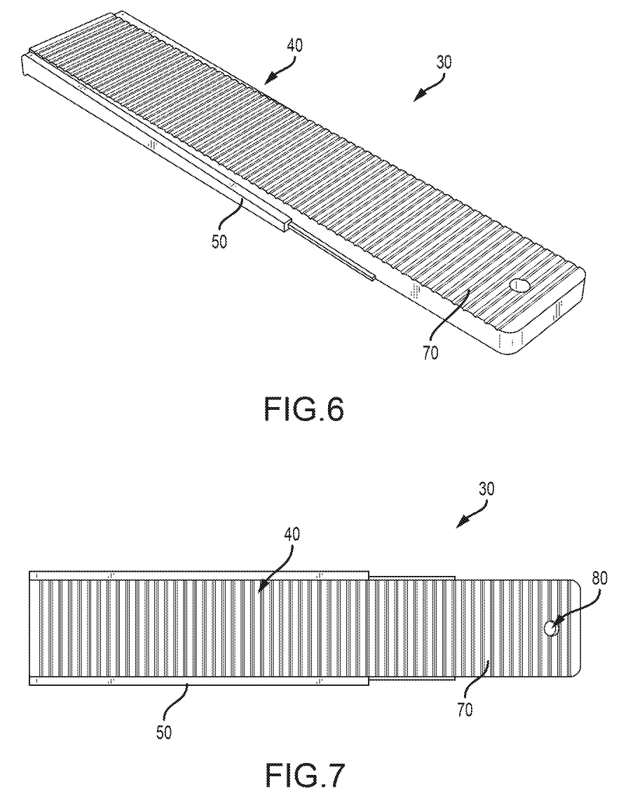

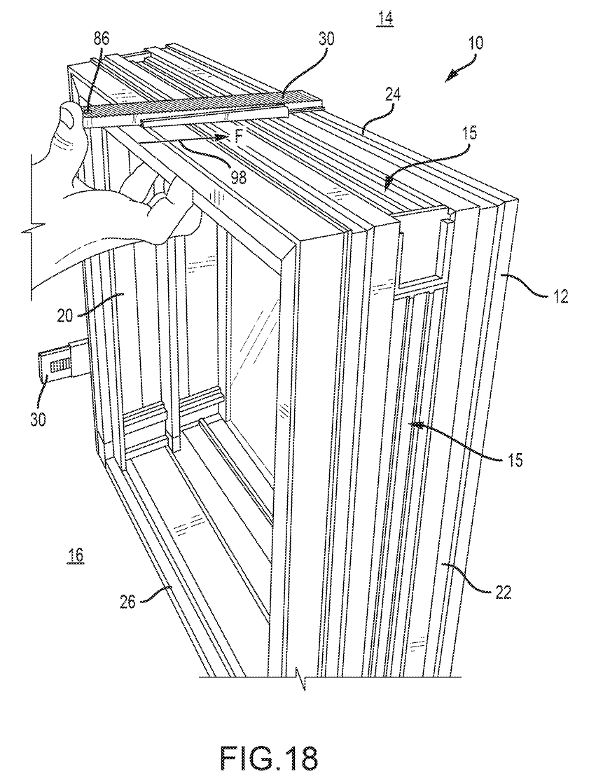

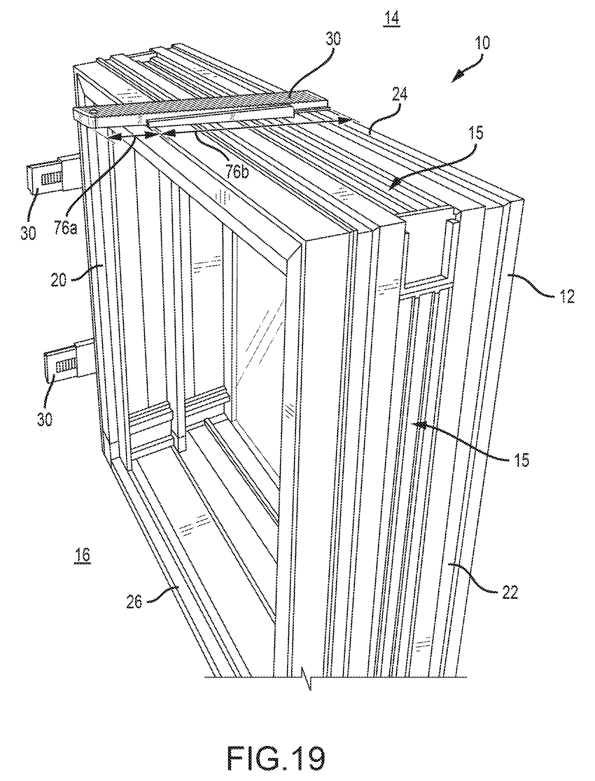

FIG. 6 is a side-oriented perspective view of a top side 40 of the shimming assembly 30. FIG. 7 is a top-view of the shimming assembly 30. FIG. 8 is a side-oriented view of a bottom side 42 of the shimming assembly 30. FIG. 9 is a bottom-view of the lower side 42 of the shimming assembly 30. During shimming, and as further described with respect to FIGS. 18-19, the top side 40 is configured to contact the rough opening framing 4. The bottom side 42 defines the contact feature 32, and is configured to be removably coupled to the frame 12.

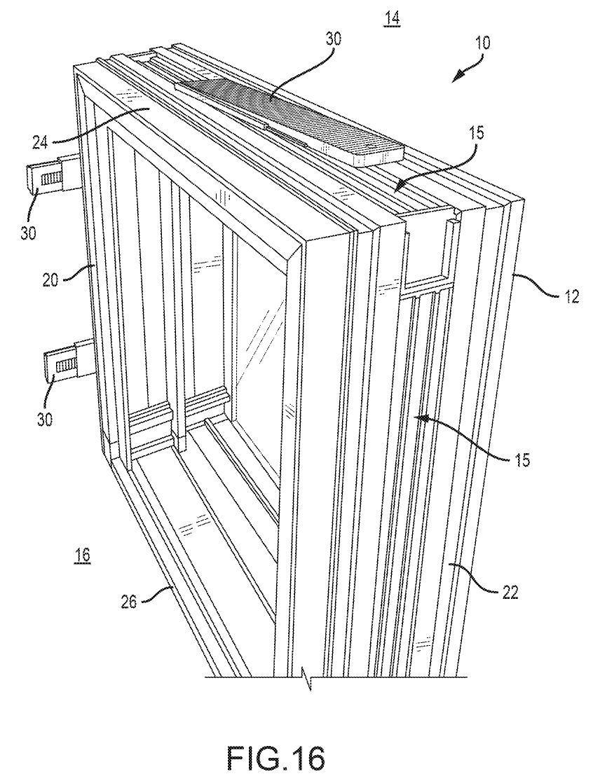

As shown in FIGS. 6-9, the shimming assembly 30 includes a carrier portion 50 and an adjustment portion 70. The adjustment portion 70 is moveably coupled to the carrier portion 50, where the adjustment portion 70 is configured to slide along a portion of the carrier portion 50 during a shimming action, which is further described with respect to FIGS. 16-19. During the shimming action, the shimming assembly 30 facilitates shimming of the fenestration unit 10 against the rough opening framing 4 to bridge the gap 6. During the shimming action, an overall height of the shimming assembly 30 is increased, which moves a position of the fenestration unit 10 within the rough opening framing 4, as will be subsequently described.

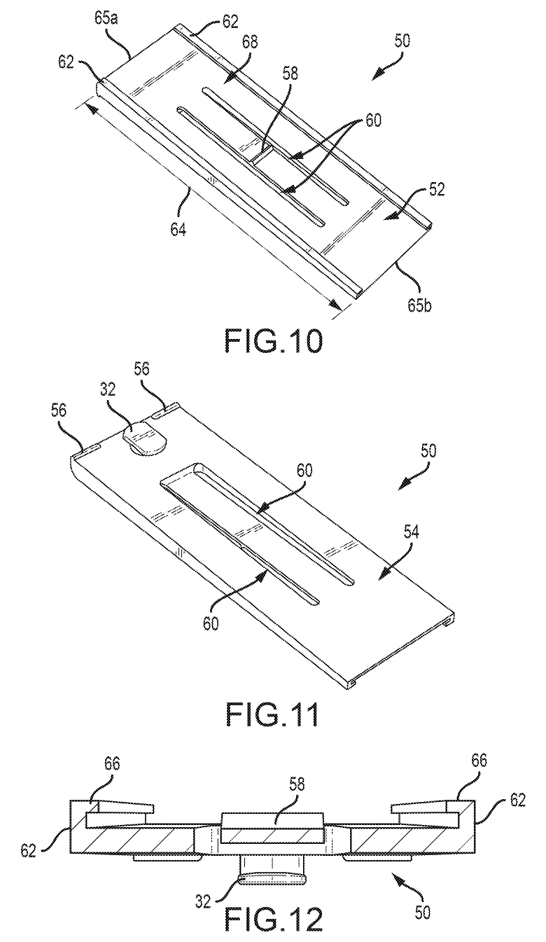

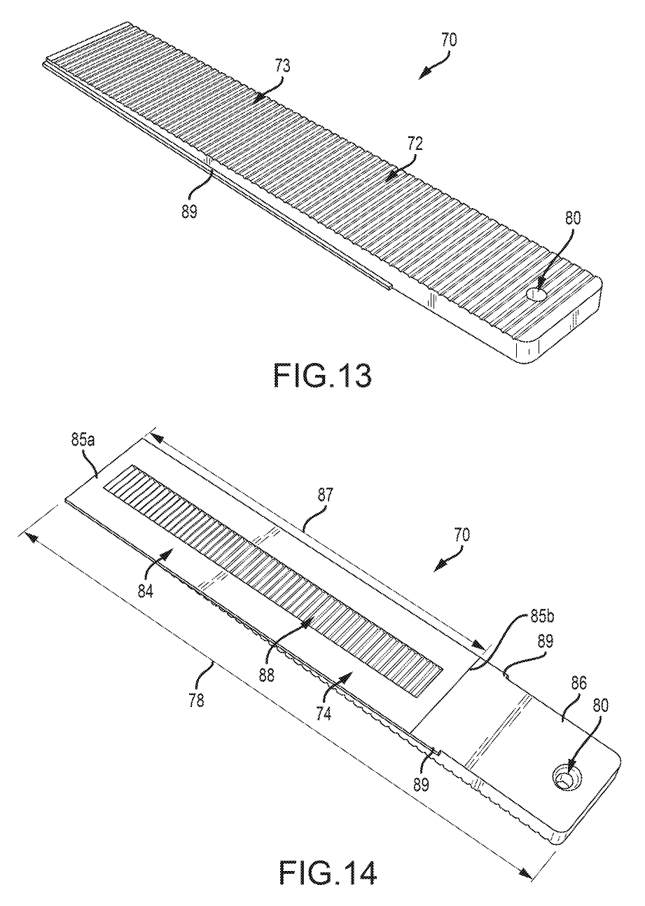

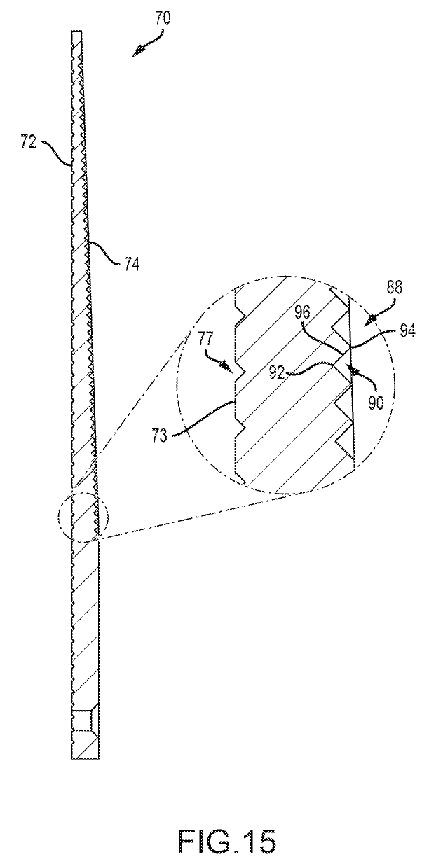

FIG. 10 is a side-oriented perspective view of an upper carrier surface 52 of the carrier portion 50, where the carrier portion 50 is isolated from the shimming assembly 30. FIG. 11 is a side-oriented perspective view of a lower carrier surface 54 of the carrier portion 50. FIG. 12 is a cross-sectional view of the carrier portion 50. FIG. 13 is a side-oriented perspective view of an upper adjustment surface 72 of the adjustment portion 70, where the adjustment portion 70 is isolated from the shimming assembly 30. FIG. 14 is a side-oriented perspective view of a lower adjustment surface 74 of the adjustment portion 70. FIG. 15 is a cross-sectional view of the adjustment portion 70.

As shown through FIGS. 6-15, the carrier portion 50 includes the upper carrier surface 52 (FIG. 10) and the lower carrier surface 54 (FIG. 11). The lower carrier surface 54 generally corresponds to a portion of the bottom side 42 of the shimming assembly 30 (FIGS. 8-9). The lower carrier surface 54 includes the contact feature 32 configured to couple the shimming assembly 30 to the frame 12. The lower carrier surface 54 may include one or more ribs 56 that abut sidewalls 17 of the channel 15 when the shimming assembly 30 is in the locked position (FIG. 5). The one or more ribs 56 assist in stabilizing the shimming assembly 30 in position along the perimeter 13 during the shimming action. The one or more ribs 56 also assist in retaining the shimming assembly 30 in the deployed configuration during shimming, where, in the deployed configuration, the longitudinal axis of the shimming assembly 30 is generally perpendicular to the longitudinal axis of the respective frame member 25.

The upper carrier surface 52 contacts a lower adjustment surface 74 of the adjustment portion 70. The upper carrier surface 52 defines at least one pawl 58 extending away from the upper carrier surface 52 that is configured to contact a plurality of teeth 88 of the adjustment portion 70 as the adjustment portion 70 slides against the carrier portion 50 during the shimming action, which is further discussed with respect to FIGS. 16-19. The plurality of teeth 88 includes teeth that are recessed relative to the lower adjustment surface 74. The upper carrier surface 52 defines a pair of cutouts 60 on either side of the at least one pawl 58 such that the at least one pawl 58 is resiliently deflectable and spring-loaded and operable to flex during the shimming action. The flex of the at least one pawl 58 may cause stress on the carrier portion 50, and the pair of cutouts 60 may be shaped to relieve, or reduce the amount of stress applied to the carrier portion 50 during the shimming action. For example, the pair of cutouts 60 may be shaped such that the carrier portion 50 is protected from yielding during the shimming action.

The upper carrier surface 52 may include a pair of retention members 62 configured to receive portions of the adjustment portion 70, such as the pair of retainers 89 (FIG. 13). The retention members 62 may extend over a length 64 of the carrier portion 50 and may each define a hook end 66 configured to stabilize the adjustment portion 70 against the carrier portion 50 during the shimming action such that the adjustment portion 70 is confined to moving along a longitudinal axis L of the carrier portion 50. The pair of retention members 62 may help prevent instances of mis-alignment of the adjustment portion 70 and carrier portion 50 during the shimming action. The pair of retention members 62 are also configured to maintain the coupling of the carrier portion 50 and the adjustment portion 70 to reduce or prevent instances of decoupling during the shimming action.

The upper carrier surface 52 defines an inclined carrier surface 68 extending along a portion of the length 64, such that a first end 65a is relatively thicker than a second end 65b. The inclined carrier surface 68 may be generally shaped as a wedge.

The adjustment portion 70 includes the upper adjustment surface 72 (FIG. 13) and the lower adjustment surface 74 (FIG. 14). The upper adjustment surface 72 generally corresponds to the top side 40 of the shimming assembly 30 (FIGS. 6-7). During the shimming action, and as will be further described, the upper adjustment surface 72 is configured to abut a portion of the rough opening framing 4. The upper adjustment surface 72 defines a plurality of break off connections 73 such that a first portion 76a (FIG. 19) of the adjustment portion 70 may be broken off from a remainder portion 76b (FIG. 19) of the adjustment portion 70 after the shimming action is complete. The break off connections 73 may define a plurality of indents 77 (FIG. 15) positioned along the length 78 of the adjustment portion 70. Each indent of the plurality of indents 77 may be spaced apart from each other by approximately 1/8 inch. In some embodiments, the first portion 76a may be broken off from the remainder portion 76b via an impact force (e.g., a hammer) without substantially damaging the adjustment portion 70 or the shimming assembly 30. The upper adjustment surface 72 may also define an aperture 80 defined though a thickness of the adjustment portion 70. The aperture 80 may be optionally configured to receive a fastener (e.g., a screw) therethrough to facilitate coupling the shimming assembly 30 to the rough opening framing 4 after the shimming action.

The lower adjustment surface 74 is configured to contact the upper carrier surface 52 of the carrier portion 50. The adjustment portion 70 defines a length 78 along a longitudinal axis, and along the length 78, the lower adjustment surface includes an inclined adjustment surface 84, a handle 86, and a pair of retainers 89.

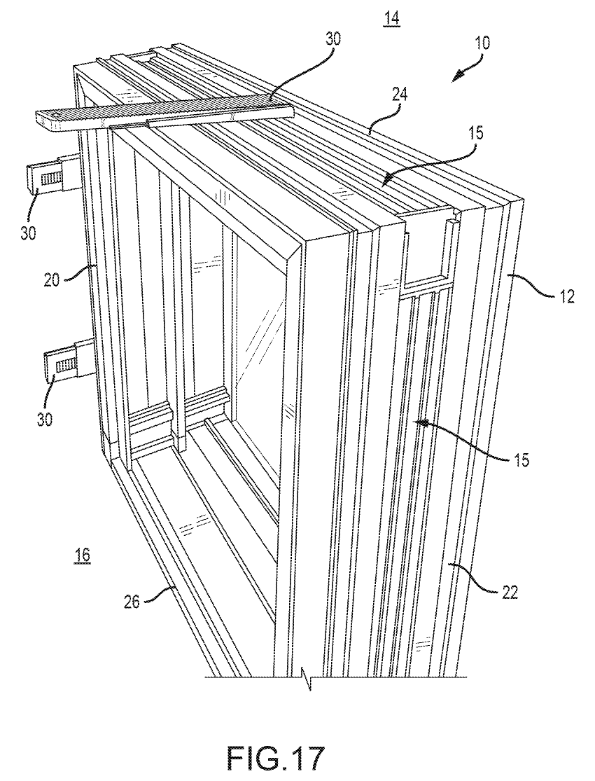

The inclined adjustment surface 84 extends from a first end 85a to a second end 85b such that a thickness of the adjustment portion 70 is larger at the second end 85b than the first end 85a. A length 87 of the inclined adjustment surface may substantially correspond to the length 64 of the inclined carrier surface 68. The inclined adjustment surface 84 may be generally shaped as a wedge, and may be complementary in shape to the inclined carrier surface 68. In some examples, when the shimming assembly 30 is in an initial configuration (e.g., FIG. 17), the first end 85a may be positioned above the first end 65a of the carrier portion 50 and the second end 85b may be positioned above the second end 65b such that an overall thickness of the shimming assembly is substantially consistent over the length of the shimming assembly 30. Said differently, the relative thinner end of the adjustment portion 70 aligns with the relative thicker end of the carrier portion 50 such that the inclined adjustment surface 84 contacts the inclined carrier surface 68 over a substantially the full length 64 of the carrier portion 50.

The inclined adjustment surface 84 defines a plurality of teeth 88 over a portion of the length. Each tooth of the plurality of teeth 88 may be positioned between approximately 0.01 inches and 0.15 inches apart from each other, optionally approximately 0.01 inches, between approximately 0.01 inches and 0.05 inches, between approximately 0.05 inches and 0.1 inches, between approximately 0.1 inches and 0.15 inches, or approximately 0.15 inches. The position of the teeth substantially corresponds to a position of the at least one pawl 58 of the carrier portion 50. During the shimming action, the inclined adjustment surface 84 longitudinally slides along the inclined carrier surface 68 in a first direction 98 (e.g., toward the interior side 14 of the fenestration unit 10 as shown in FIG. 18) such that the at least one pawl 58 contacts and engages the plurality of teeth 88. As shown in FIG. 15, each tooth of the plurality of teeth 88 may define a step 90, including a high point 92 and a low point 94 with a ramp portion 96 therebetween. When sliding in response to an external force F (FIG. 18), the at least one pawl 58 initially engages the low point 94 and slides along the ramp portion 96 until reaching the high point 92. Once a frictional engagement with the high point 92 is overcome, the at least one pawl 58 contacts the low point of the adjacent tooth and the process repeats for the adjacent tooth. This adjustment continues until the fenestration unit 10 is positioned as desired such that the fenestration unit 10 achieves a shimmed position.

During the adjustment and shimming action, an overall height, or overall thickness, of the shimming assembly 30 is increased as the at least one pawl 58 moves across each tooth of the plurality of teeth 88. In some embodiments, the overall height of the shimming assembly increases 0.01 inches at each tooth of the plurality of teeth (e.g., generally corresponding to the spacing between adjacent teeth). The increase in height is facilitated by the inclined adjustment surface 84 sliding across the complementary inclined carrier surface 68.

The shimmed position occurs when the fenestration unit 10 is shimmed within the rough opening framing 4. The shimming assembly 30 is operable to raise the fenestration unit 10 (e.g., when the shimming assembly 30 is positioned and adjusted at the lower member 26), move the fenestration unit 10 side to side (e.g., when the shimming assembly 30 is positioned and adjusted at one or both of the first and second side members 20, 22), or lower the fenestration unit 10 (e.g., when the shimming assembly 30 is positioned and adjusted at the upper member 24). At the shimmed position, a portion of the upper adjustment surface 72 contacts the rough opening framing 4. At the shimmed position, the shimming assembly 30 reaches a stop point and the at least one pawl 58 locks to a tooth of the plurality of teeth 88, and the relative position between the carrier portion 50 and the adjustment portion 70 is locked, which in turn, locks the shimming assembly 30 at the increased height.

The interaction between the at least one pawl 58 and the plurality of teeth 88 defines a ratcheting mechanism such that the adjustment portion 70 is capable of moving in the first direction 98 (e.g., as shown in FIG. 18 toward the interior side 14 of the fenestration unit 10), but is substantially prevented from moving in a second direction opposite to the first direction 98 (e.g., toward the exterior side 16 of the fenestration unit 10). As such, when the shimmed position is reached, engagement of the at least one pawl 58 and the plurality of teeth 88 substantially lock the position of the adjustment portion 70 in place along the carrier portion 50 at a stop point (e.g., FIG. 19). In various embodiments, the ratcheting mechanism is releasable (e.g., using a tool to lift the at least one pawl 58) in order to unlock the ratchet arrangement (e.g., the teeth 88 and at least one pawl 58) and allow adjustment of the shimming assembly 30 and/or fenestration unit 10.

During the shimming action at the upper member 24, as the adjustment portion 70 slides along the carrier portion 50, the fenestration unit 10 is pushed downwards within the rough opening framing 4, and the adjustment portion 70 raises upward within the rough opening framing 4 such that an overall height of the shimming assembly 30 is increased to bridge the gap 6 between the fenestration unit 10 and the rough opening framing 4. In some examples, the adjustment portion 70 raises approximately 0.01 inches in overall height after passing each tooth (e.g., generally corresponding to the spacing between each tooth) and at the same time the fenestration unit 10 is pushed downward approximately 0.01 inches within the rough opening framing 4. In other embodiments, the adjustment portion 70 raises between approximately 1/64 inches and 0.1 inches, optionally approximately 1/64 inches, approximately 1/32 inches, approximately 1/16 inches, or approximately 0.1 inches, though any interval therebetween is also contemplated. In such embodiments, the fenestration unit 10 is pushed downward a corresponding amount (e.g., 1/64 inches, 1/32 inches, 1/16 inches, or 0.1 inches) within the rough opening framing 4. The shimming action is further discussed with respect to FIGS. 16-19.

During the shimming action at the lower member 26, a similar action occurs as the adjustment portion 70 slides along the carrier portion 50. The fenestration unit 10 is raised upwards within the rough opening framing 4 and the overall height of the shimming assembly 30 is increased. In some examples, the adjustment portion 70 increases approximately 0.01 inches in overall height after passing each tooth (e.g., generally corresponding to the spacing between each tooth) and at the same time the fenestration unit 10 is raised upwards approximately 0.01 inches within in the rough opening framing 4. In other embodiments, the adjustment portion 70 raises between approximately 1/64 inches and 0.1 inches, optionally approximately 1/64 inches, approximately 1/32 inches, approximately 1/16 inches, or approximately 0.1 inches, though any interval therebetween is also contemplated. In such embodiments, the fenestration unit 10 is raised upwards a corresponding amount (e.g., 1/64 inches, 1/32 inches, 1/16 inches, or 0.1 inches) within the rough opening framing 4.

During the shimming action at either of the first and second side members 20, 22, as the adjustment portion 70 slides along the carrier portion 50, the fenestration unit 10 is moved side-to-side, or laterally, within the rough opening framing 4. The adjustment portion 70 increases in height, or thickness, to move and adjust the position of the fenestration unit 10 relative to the rough opening framing 4. In some examples, the adjustment portion 70 increases approximately 0.01 inches in overall thickness after passing each tooth (e.g., generally corresponding to the spacing between each tooth) and at the same time the fenestration unit 10 is moved laterally approximately 0.01 inches within in the rough opening framing 4. In other embodiments, the adjustment portion 70 raises between approximately 1/64 inches and 0.1 inches, optionally approximately 1/64 inches, approximately 1/32 inches, approximately 1/16 inches, or approximately 0.1 inches, though any interval therebetween is also contemplated. In such embodiments, the fenestration unit 10 is moved side-to-side a corresponding amount (e.g., 1/64 inches, 1/32 inches, 1/16 inches, or 0.1 inches) within the rough opening framing 4.

Further to FIG. 13, the lower adjustment surface 74 defines the pair of retainers 89 that are configured to be received within the pair of retention members 62. The pair of retainers 89 may substantially extend over the length 87 of the inclined adjustment surface 84. The engagement of the pair of retainers 89 and pair of retention members 62 stabilize the adjustment portion 70 against the carrier portion 50 such that the adjustment portion 70 is confined to moving along the longitudinal axis L of the carrier portion 50, which may help prevent instances of mis-alignment of the adjustment portion 70 and carrier portion 50 during the shimming action. The engagement of the pair of retention members 62 and pair of retainers 89 maintains the coupling between the carrier portion 50 and the adjustment portion 70 to reduce or prevent instances of decoupling of the two components during the shimming action.

The handle 86 of the adjustment portion 70 extends from the inclined adjustment surface 84 and allows an installer to engage the shimming assembly 30 to initiate the shimming action. The user can manually adjust the shimming assembly 30 (e.g., by hand) by pressing on the handle 86. If desired, a tool (e.g., a hammer) can be used to apply force to the handle 86 to adjust the shimming assembly 30. In some embodiments, the handle 86, or a substantial portion thereof, does not engage the carrier portion 50 and instead is configured to be broken off (e.g., as part of the first portion 76a) after a desired shimming operation is complete.

FIGS. 16-19 illustrate installation and shimming steps. FIG. 16 illustrates the shimming assembly 30 coupled to the fenestration unit 10 in an unlocked position. FIG. 17 illustrates the shimming assembly 30 in a locked position and an initial configuration prior to the shimming action. FIG. 18 illustrates the shimming assembly 30 at an intermediate position during the shimming action. FIG. 19 illustrates the shimming assembly 30 in a final, shimmed configuration after the shimming action is complete. Although FIGS. 16-19 are shown with respect to one shimming assembly 30 coupled to the upper member 24 of the fenestration unit 10, similar steps may be followed for a plurality shimming assemblies 30 coupled about the perimeter 13 of the frame 12.

As shown in FIG. 16, an installer may couple the shimming assembly 30 to the fenestration unit 10 prior to the shimming action. To couple the shimming assembly 30 to the fenestration unit 10, the installer places the contact feature 32 within the channel 15 in the unlocked position (FIG. 4). In the unlocked position, the shimming assembly 30 extends substantially parallel to the upper member 24 and substantially along the perimeter 13 of the frame 12. No additional tooling may be required to couple the shimming assembly 30 to the frame 12.

As shown in FIG. 17, the installer may rotate the shimming assembly 30 about the contact feature 32 to transition the shimming assembly 30 to the locked position (FIG. 5). In the locked position, the shimming assembly 30 extends substantially perpendicular to the upper member 24 and extends outwardly relative to the exterior side 16 of the fenestration unit 10. Although one shimming assembly 30 is shown, additional shimming assemblies 30 may be coupled to the upper member 24.

Additional shimming assemblies 30 may be positioned at the other frame members 25 following similar steps as described with respect to FIGS. 16-17. For example, FIGS. 16-17 show another shimming assembly 30 coupled to the first side member 20. Before or after attaching the shimming assembly 30 to the upper member 24, the installer may couple one or more shimming assemblies 30 to one or both of the first and second side members 20, 22. The shimming assemblies 30 may be coupled within the channel 15 of the first and/or second side members 20, 22 in the unlocked position (FIG. 4). In the unlocked position, the shimming assembly 30 extends substantially parallel to the first and/or second side member 20, 22 and substantially along the perimeter 13 of the frame 12. The installer may then rotate the shimming assembly 30 about the contact feature 32 to transition the shimming assembly 30 to the locked position (FIG. 5) such that the shimming assembly 30 extends substantially perpendicular to the first and/or second side member 20, 22 and extends outwardly toward the exterior side 16 of the fenestration unit 10.

Similarly, one or more shimming assemblies 30 may be coupled to the lower member 26 before or after attaching shimming assemblies 30 to the upper member 24 and/or first and second side members 20, 22. The installer may couple one or more shimming assemblies 30 within the channel 15 of the lower member 26 in the unlocked position (FIG. 4) such that the shimming assembly 30 extends substantially parallel to the lower member 26 and substantially along the perimeter 13 of the frame 12. The installer may then rotate the shimming assembly 30 about the contact feature 32 to transition the shimming assembly 30 to the locked position (FIG. 5) such that the shimming assembly 30 extends substantially perpendicular to the lower member 36 and extends outwardly toward the exterior side 16 of the fenestration unit 10.

In other embodiments, the shimming assembly 30 is coupled to the fenestration unit 10 at a manufacturing location prior to shipping from the manufacturing location. The fenestration unit 10 may be shipped with shimming assembly 30 in the unlocked configuration such that the installer may simply rotate the shimming assembly 30 to the locked position (FIG. 17) prior to shimming. In at least this manner, the shimming assembly 30, or plurality of similar shimming assemblies, may be rotated to a “stowed” position which may be easily packed for shipping, with one or more shimming assemblies 30 extending substantially parallel to the frame members 25 (e.g., at the unlocked position of FIG. 4) to reduce the overall profile of the fenestration unit 10 and shimming assembly 30.

From the initial, un-shimmed configuration of FIG. 17, the installer may apply an external force F (e.g., a push) to the handle 86 to initiate sliding between the adjustment portion 70 and the carrier portion 50 and move the shimming assembly 18 to the intermediate position of FIG. 18. While sliding, the at least one pawl 58 engages the plurality of teeth 88, as discussed above. In some embodiments, when the at least one pawl 58 overcomes engagement with one tooth of the plurality of teeth 88, an audible cue or “click” is produced to provide the user feedback (e.g., tactile and/or audible). For example, the installer may listen for the audible cue or feel tactile feedback (i.e., the “clicks”) during the shimming action to help the installer confirm the carrier portion 50 and the adjustment portion 70 are properly engaged and aligned with respect to each other and that proper adjustment is occurring. In some embodiments, each “click” may correspond to a particular change in height. For example, each “click” may correspond to a fractional inch height adjustment, and a user may count the “clicks” to estimate an amount of height adjustment that is occurring during a shimming operation. This feedback can be increased in intensity (e.g., audible and/or tactile) by adjusting the spring bias and material selection for the carrier portion 50 and/or the adjustment portion 70.

As the external force F is applied by the installer, the adjustment portion 70 slides across the carrier portion 50 and the adjustment portion 70 raises in height incrementally toward the rough opening framing 4. In some embodiments, the adjustment portion 70 raises approximately 0.01 inches as each tooth of the plurality of teeth 88 is engaged (e.g., each “click” corresponds to 0.01 inches). As discussed above, other height changes of the adjustment portion 70 are contemplated including, but not limited to, 1/64 inches, 1/32 inches, 1/16 inches, 0.1 inches, or any interval therebetween. In some embodiments, once the fenestration unit 10 has been shimmed to a desired position, further adjustment of the shimming assembly 30 may cease, defining a stop point. for example, once the frame member 20, 22, 24, 26 reaches the shimmed position as desired, the external force F can be removed from the shimming assembly 30, and the adjustment portion 70 and the carrier portion 50 become locked in position at the stop point such that the adjustment portion 70 no longer slides along the carrier portion 50 and the adjustment portion 70 no longer moves in response to the external force F. At this stop point, the fenestration unit 10 is held at the shimmed position by the one or more shimming assemblies 30. This shimming process may be repeated for each of the shimming assemblies 30 coupled to the fenestration unit 10. Once each shimming assembly 30 is locked at a stop point, the fenestration unit 10 is shimmed within the rough opening framing 4.

After the shimming process, the fenestration unit 10 is anchored to the rough opening framing 4. In some embodiments, the frame 12 of the fenestration unit 10 is anchored to the rough opening framing 4 via one or more fasteners (e.g., screws) driven though portions of the frame 12. In some embodiments, one or more anchoring clips 100, such as those disclosed in U.S. Application Number: 18/646,289 (Attorney Docket No.: 426998.001099) and/or those disclosed in U.S. Application Number: 18/436,123 (Attorney Docket No.: 426998.001086) are utilized to anchor the fenestration unit 10 to the rough opening framing 4, the disclosures of which are incorporated herein by reference.

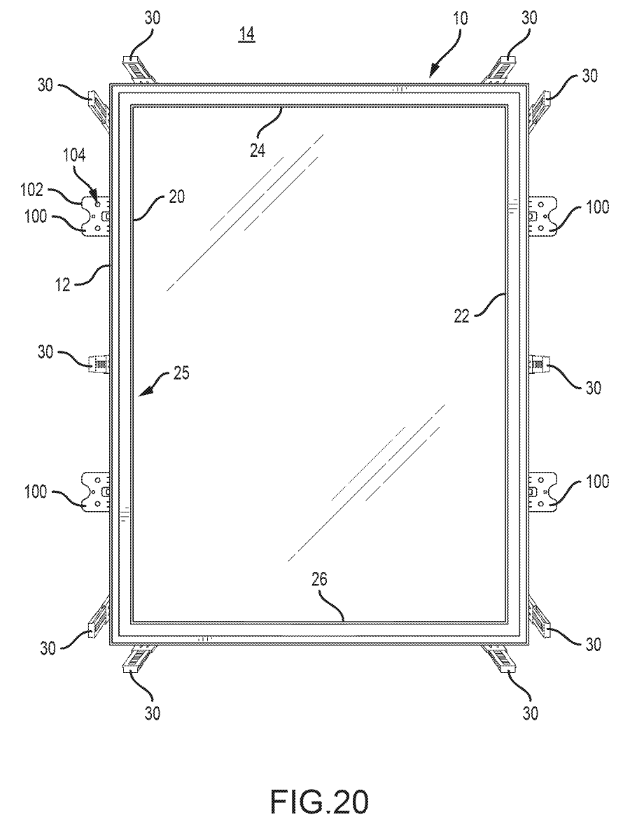

FIG. 20 shows the interior side 14 of the fenestration unit 10 including one or more anchoring clips 100 coupled to the perimeter 13 of the frame 12. The one or more anchoring clips 100 are configured to anchor and stabilize the fenestration unit 10 within the rough opening framing 4 during installation of the fenestration unit 10. In particular, the one or more anchoring clips 100 are shown coupled to the first side member 20 and the second side member 22 (e.g., two to each). As shown, four (4) anchoring clips 100 may be used, although greater (e.g., 6, 8, 10, 12, etc.) or fewer (e.g., 2) anchoring clips 100 are contemplated. Generally, embodiments will include at least four (4) anchoring clips 100, two upper anchoring clips 100 toward the upper member 24 and two lower anchoring clips 100 toward the lower member 26. In some embodiments, additional anchoring clips 100 may be coupled to the perimeter 13 of the frame 12 at one or both of the upper member 24 and the lower member 26.

As shown, the one or more anchoring clips 100 are in a deployed configuration in which a longitudinal axis of a first leg 102 of the one or more anchoring clips 100 extends generally perpendicular to the longitudinal axis of the respective frame member 25 and away from a general center of the frame 12. In the deployed configuration, when the fenestration unit 10 is placed within the rough opening, the first leg 102 may contact an interior-facing side of the rough opening framing 4 (e.g., an interior side of the structure 2). The first leg 102 may define one or more apertures 104 configured to receive fasteners therethrough to anchor the fenestration unit 10 to the rough opening framing 4.

In some embodiments, and as discussed with respect to FIG. 13, a fastener is optionally driven through aperture 80 of the shimming assembly 30 to couple the shimming assembly 30 to the fenestration unit 10. Additionally, or alternatively, a fastener may be driven through both the carrier portion 50 and the adjustment portion 70 to couple the shimming assembly 30 to the rough opening framing 4 after shimming and after anchoring the fenestration unit 10 within the rough opening. After the fenestration unit 10 is shimmed and anchored, subsequent installation steps may proceed (e.g., centering, leveling, sealing, and the like).

In some embodiments, once the fenestration unit 10 is shimmed and anchored to the rough opening framing 4 (FIG. 19), the first portion 76a of the shimming assembly may be broken off. In some embodiments, a tool (e.g., a hammer) may be used by the installer to apply an impact force to remove the first portion 76a at the respective break off connection 73. After removal of the first portion 76a, the remainder portion 76b will remain in place within the gap 6 between the fenestration unit 10 and the rough opening framing 4.

The shimming action may be repeated for any number of shimming assemblies 30 coupled to the fenestration unit 10.

Various modifications and additions can be made to the exemplary embodiments discussed without departing from the scope of the present invention. For example, while the embodiments described above refer to particular features, the scope of the invention also includes embodiments having different combinations of features and embodiments that do not include all of the above described features.

What is claimed is:

1. A fenestration unit configured to be received within a rough opening defined by a rough opening framing, the fenestration unit comprising:
a frame having a perimeter, the perimeter including a first side member, a second side member opposite the first side member, a upper member, and a lower member opposite the upper member, the frame defining a channel along at least a portion of the perimeter; and
a shim assembly including,
a carrier portion having an upper carrier surface and a lower carrier surface, the lower carrier surface having a contact feature configured to be received within the channel to couple the shim assembly to the frame, the upper carrier surface defining at least one pawl extending away from the upper carrier surface, and
an adjustment portion having an upper adjustment surface and a lower adjustment surface, the lower adjustment surface defining a plurality of teeth, wherein the adjustment portion is configured to slide longitudinally along the carrier portion such that the at least one pawl is configured to slide along the plurality of teeth until a desired level of shimming is reached, at which point the carrier member and the adjustment member are locked in position.

2. The fenestration unit of claim 1, wherein the shim assembly is coupled to one of the first side member, the second side member, the upper member, or the lower member.

3. The fenestration unit of claim 1, wherein the adjustment portion is configured to slide along the carrier portion such that the at least one pawl is configured to slide along a portion of the plurality of teeth.

4. The fenestration unit of claim 1, wherein engagement of the at least one pawl and the plurality of teeth produces an audible cue.

5. The fenestration unit of claim 1, wherein each tooth of the plurality of teeth are spaced approximately 0.01 inches apart from each other.

6. The fenestration unit of claim 1, wherein the at least one contact feature is rotatable between a locked and unlocked configuration within the channel.

7. The fenestration unit of claim 1, wherein the at least one contact feature is a non-penetrating feature.

8. The fenestration unit of claim 1, wherein the shimming assembly includes a handle, and the handle is connected to the shimming assembly by a break off connection.

9. The fenestration unit of claim 1, wherein the lower adjustment surface defines an inclined adjustment surface and the upper carrier surface defines an inclined carrier surface, and wherein the lower adjustment surface and the upper carrier surface are configured to slide across one another in response to an external force.

10. The fenestration unit of claim 9, wherein the carrier portion defines a pair of retention members extending longitudinally along the inclined carrier surface, and the adjustment portion defines a pair of retainers extending longitudinally along the inclined adjustment surface, the engagement of the pair of retention members and the pair of retainers configured to maintain a coupling of the carrier portion and the adjustment portion.

11. The fenestration unit of claim 10, wherein each retention members of the pair of retention members defines a hooked end.

12. A method of shimming a fenestration unit within a rough opening of a structure, the fenestration unit including a frame having a perimeter including a first side member, a second side member opposite the first side member, a upper member, and a lower member opposite the upper member and defining an interior side facing an interior of the structure and an exterior side facing an exterior of the structure, the rough opening defined by a rough opening framing, the method comprising:
rotating a shimming assembly coupled to the perimeter of the frame about a non-penetrating contact feature coupled to the shimming assembly such that the shimming assembly extends outwardly from the perimeter of the frame toward the exterior side;
applying an external force to a portion of the shimming assembly such that an adjustment portion of the shimming assembly slides longitudinally relative to a carrier portion of the shimming assembly, wherein at least one pawl of the carrier portion engages a plurality of teeth of the adjustment portion; and
removing the external force when a desired level of shimming is reached, wherein a position of the adjustment portion and the carrier portion is locked.

13. The method of claim 12, further comprising anchoring the fenestration unit to the rough opening framing, and optionally coupling an anchoring bracket of the fenestration unit to the rough opening framing.

14. The method of claim 13, further comprising breaking off a first portion of the shimming assembly after anchoring the fenestration unit.

15. The method of claim 12, further comprising rotating the shimming assembly approximately 90 degrees to lock the non-penetrating contact feature to the perimeter of the frame such that a rib of the carrier portion engages a portion of the frame.

16. The method of claim 12, wherein the shimming assembly is coupled to the upper frame member, the method further comprising lowering a position of the fenestration unit relative to the rough opening framing.

17. The method of claim 12, wherein the shimming assembly is coupled to one of the first or second frame members, the method further comprising moving a position of the fenestration unit laterally relative to the rough opening framing.

18. The method of claim 12, wherein the shimming assembly is coupled to the lower frame member, the method further comprising raising a position of the fenestration unit relative to the rough opening framing.

19. The method of claim 12, further comprising releasing the at least one pawl from a tooth of the plurality of teeth to unlock the position of the adjustment portion and the carrier portion.

20. The method of claim 12, further comprising coupling the shimming assembly to a channel extending along a portion of the perimeter of the frame, wherein the shimming assembly is coupled to one of the upper member, the first side member, the second side member, and the lower member, optionally wherein coupling the shimming assembly to the channel requires no additional tooling.
